(19) United States
(12) Patent Application Publication
(10) Pub. No.: US 2018/0274722 A1
(43) Pub. Date: Sep. 27, 2018

(54) DEVICE FOR MOUNTING TO A SURFACE AND HAVING A LOCKING MECHANISM

(71) Applicant: Helen of Troy Limited, Belleville (BB)

(72) Inventors: Morris Elijah Worden, IV, New York, NY (US); Edward J. Laganis, Hoboken, NJ (US); Lingxiu Wu, Brooklyn, NY (US); Lynna A. Borden, Brooklyn, NY (US); Conor P. McNamara, Montclair, NJ (US)

(21) Appl. No.: 15/466,950

(22) Filed: Mar. 23, 2017

(51) Int. Cl. F16M 13/02; F16B 47/00; F16B 45/00; A47K 10/12; A47K 5/02; A47J 47/16

(52) U.S. Cl. CPC F16M 13/022; F16B 47/003; F16B 45/00; G03B 17/561; A47K 5/02; A47J 47/16; A47K 10/12

(57) ABSTRACT

A device for mounting to a surface includes a surface attachment device and an accessory assembly selectively connectable to the surface attachment device. The surface attachment device includes a surface attachment member and a latch operatively connected with the surface attachment member. The surface attachment member includes a contact surface configured to contact a surface against which the surface attachment device is to be retained. The accessory assembly is selectively rotatable about a rotational axis with respect to the surface attachment device when connected with the surface attachment device. The accessory assembly includes a catch and a spring member cooperating with the catch. The spring member biases the catch in a direction not parallel with the rotational axis.

### BACKGROUND

Bathrooms, kitchens, and even other rooms in a household or building include wall-mounted accessories for supporting items. For example, many household bathrooms include toothbrush holders, towel hooks, towel rings, bars, shelves, and soap dishes. In some bathrooms, these wall-mounted accessories can be cemented into a tile wall providing a relatively permanent connection to the wall. Other relatively permanent connections, such as crew-mounted accessories, are also known.

Some wall-mounted accessories are attached to the wall in a less permanent manner. For example, double-sided adhesive can be used to mount accessories to a wall. Suction cups have also been used to mount an accessory to a wall or other surface, e.g., a mirror or glass shower door. These relatively less permanent accessory mounts may provide good holding power; however, often times these accessory mounts only allow for one accessory to be attached to the double-sided adhesive or suction cup. Where a modular design is provided, e.g., a design in which different accessories can mount to the suction cup or adhesive, improvements in the attachment of the accessory mount to the suction cup or double-sided adhesive can be gained.

### SUMMARY

In view of the foregoing, a device for mounting to a surface includes a surface attachment device, an accessory assembly selectively connectable to the surface attachment device and a locking mechanism. The surface attachment device includes a surface attachment member having a contact surface configured to contact a surface against which the surface attachment device is to be retained. The accessory assembly is selectively rotatable about a rotational axis with respect to the surface attachment device when connected with the surface attachment device. The locking mechanism includes a latch, a catch and a spring member. The latch is provided with one of the surface attachment device and the accessory assembly. The catch and the spring member are provided with the other of the surface attachment device and the accessory assembly. The spring member cooperates with the catch such that the spring member biases the catch in a direction not parallel with the rotational axis.

A method for attaching an accessory assembly to a surface includes attaching a surface attachment device to the surface. The method further includes moving the accessory assembly in an axial direction with respect to the surface attachment device. The method further includes rotating the accessory assembly about a rotational axis with respect to the surface attachment device such that a latch moves a catch, which is biased by a spring member, in a direction not parallel with the rotational axis until the catch engages the latch in a locked position, at which time rotational movement of the accessory assembly with respect to the surface attachment device is precluded.

### BRIEF DESCRIPTION OF THE DRAWINGS

FIG. 1 is a perspective view of a device for mounting to a surface.

FIG. 2 is a perspective view of a surface attachment device and an accessory assembly of the device in FIG. 1 with the accessory assembly disconnected from the surface attachment device.

FIG. 3 is another perspective view of the surface attachment device and the accessory assembly from an opposite angle of that shown in FIG. 2.

FIG. 4 is an exploded view of the device depicted in FIG. 1.

FIG. 5 is another exploded view of the device depicted in FIG. 1 from an angle opposite of that shown in FIG. 4.

### DETAILED DESCRIPTION

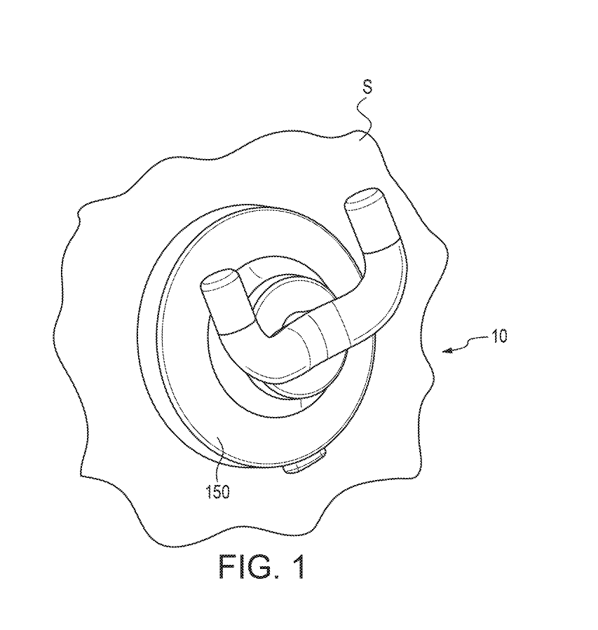

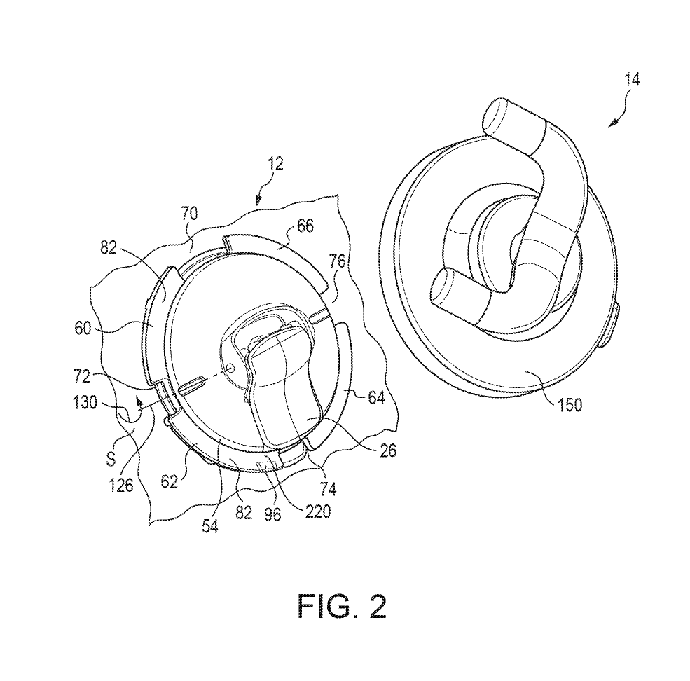

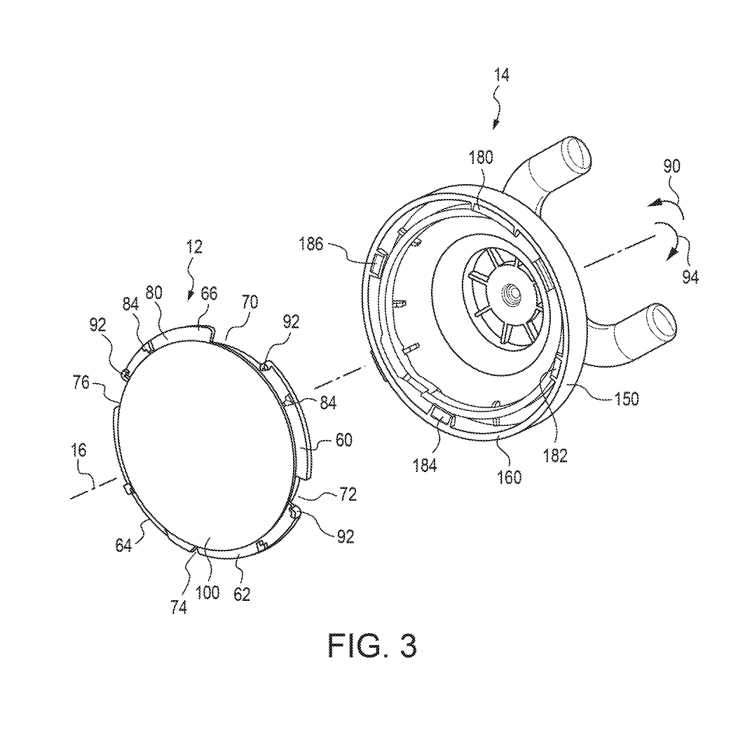

FIG. 1 depicts a device 10 for mounting to a surface S. The surface S can be the surface of a wall, a mirror, a door, or any other surface to which a surface-mounted accessory for supporting or storing an item may be useful. With reference to FIGS. 2 and 3, the device 10 includes a surface attachment device 12 and an accessory assembly 14 selectively connectable to the surface attachment device 12. The device 10 includes a locking mechanism to facilitate connecting the accessory assembly 14 to the surface attachment device 12. With reference to FIG. 3, the accessory assembly 14 is selectively rotatable about a rotational axis 16 with respect to the surface attachment device 12 when the accessory assembly 14 is connected with the surface attachment device 12. The accessory assembly 14 is rotatable with respect to the surface attachment device 12 into a locked position, which is shown in FIG. 1, in which rotational movement of the accessory assembly 14 with respect to the surface attachment device 12 is precluded. Also when in the locked position, axial movement parallel with the rotational axis 16 of the accessory assembly 14 with respect to the surface attachment device 12 may also be precluded. The surface attachment device 12 is configured to attach to the surface S first, and then the accessory assembly 14 connects with the surface attachment device 12 to connect the accessory assembly 14 to the surface S through the surface attachment device 12.

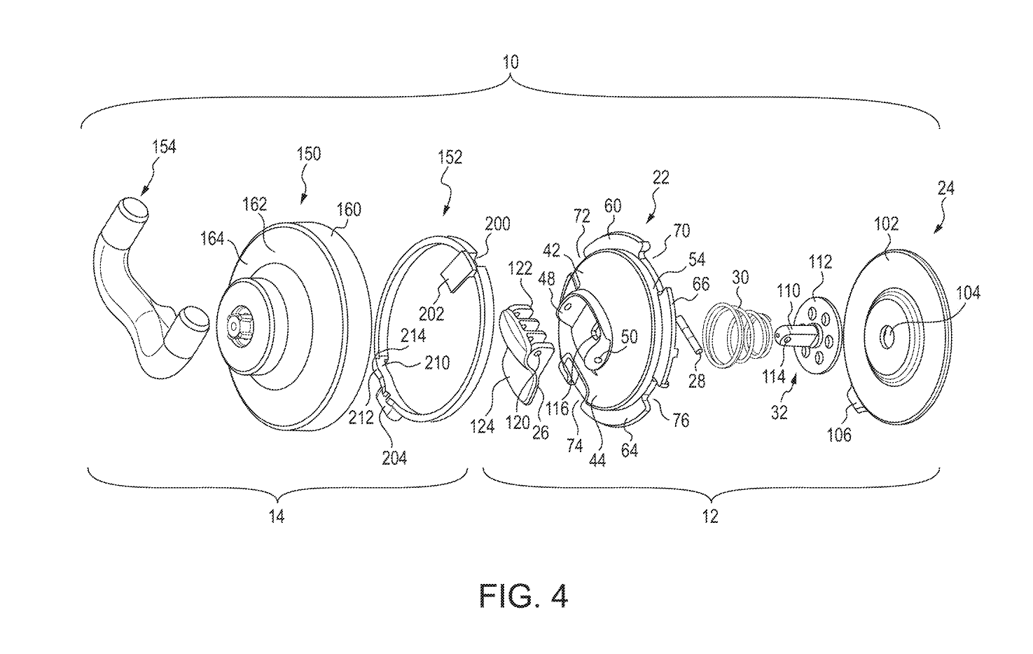

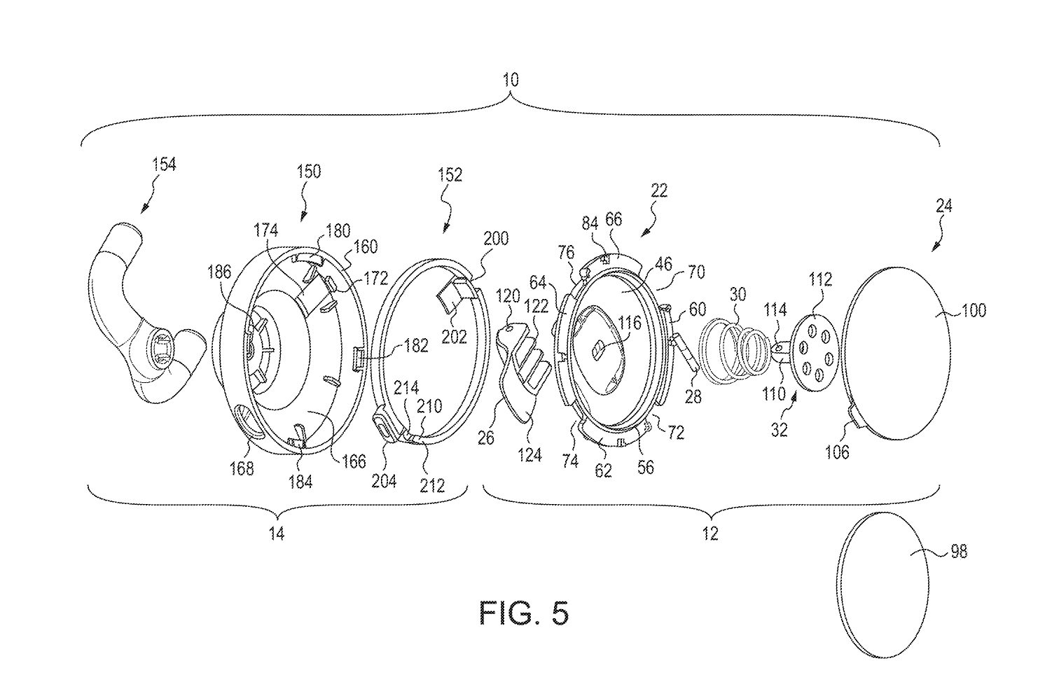

With reference to FIGS. 4 and 5, the surface attachment device 12 includes a surface attachment device housing 22, a surface attachment member 24, and an actuator assembly including a lever 26, an axle 28, a spring 30, and a connector 32. The surface attachment device housing 22 includes a main body section 42, which is generally circular in the illustrated embodiment. The main body section 42 defines an outer surface 44 and an inner surface 46. An upside down U-shaped (per the orientation shown in FIG. 4) projection 48 extends outwardly from the outer surface 44 and away from the surface attachment member 24. The upside down U-shaped projection 48 includes two aligned axle loading holes 50 that are used when assembling the surface attachment device 12 to connect the lever 26 with the connector 32. The surface attachment device housing 22 also includes an annular shoulder 54 that is radially offset from the rotational axis 16 (FIG. 3) as more clearly seen in FIG. 5. The surface attachment device housing 22 also includes a contact edge 56, which is circular in the depicted embodiment. The contact edge 56 cooperates with the surface attachment member 24 to deform the surface attachment member 24 in a manner that will be described in more detail below.

The surface attachment device 12 includes at least one tab (tabs 60, 62, 64, and 66 are depicted in the illustrated embodiment) defining at least one notch (notches 70, 72, 74, and 76 are provided in the illustrated embodiment). With reference to FIG. 2, the surface attachment device housing 22 includes a plurality of outwardly extending tabs: a first tab 60, a second tab 62, a third tab 64, and a fourth tab 66. The tabs 60, 62, 64, and 66 define a plurality of notches: a first notch 70, a second notch 72, a third notch 74, and a fourth notch 76. A fewer or greater number of notches and/or tabs could be provided. Each of the outwardly extending tabs 60, 62, 64, and 66 includes a respective forward facing surface 80, which faces the surface S when the surface attachment device 12 is attached to the surface S. The forward facing surfaces 80 on each of the outwardly extending tabs 60, 62, 64, and 66 are coplanar with each other. Each of the outwardly extending tabs 60, 62, 64, 66 also includes a rearward facing surface 82, which is opposite the forward facing surface 80, and faces away from the surface S when the surface attachment device 12 is attached with the surface S. With reference to FIGS. 3 and 5, lock stop members 84 extend in a forward axial direction from the forward facing surface 80 on each outwardly extending tab 60, 62, 64, and 66. Each lock stop member 84 is circumferentially spaced from a respective notch in a locking rotational direction 90 (FIG. 3) so as to cooperate with the accessory assembly 14 in a manner described in further detail below. Unlock stop members 92 extend in a forward axial direction from the forward facing surface 80 on the first tab 60, the second tab 62, and the fourth tab 66 in the illustrated embodiment. Each of the unlock stop members 92 is positioned at a radial edge of the respective outwardly extending tabs 60, 62, and 66 on a side of the respective notches 70, 72, and 76 in an unlock rotational direction 94 (see FIG. 3). Each unlock stop member 92 cooperates with the accessory assembly 14 in a manner described in further detail below.

In the illustrated embodiment and with reference back to FIG. 2, the surface attachment device 12 also includes a latch 96 that is operatively connected with the surface attachment member 24. The latch 96 is a component of the locking mechanism for the device 10. In the illustrated embodiment, the latch 96 is provided on the rearward facing surface 82 of the second tab 62 adjacent the third notch 74 and extends in a rearward axial direction from a rearward facing surface 82. The latch 96 is provided on a peripheral edge of the second tab 62 and is radially spaced from the annular shoulder 54. The latch 96 is ramped upwardly moving from the third notch 74 toward the second notch 72.

The surface attachment member 24 in the illustrated embodiment is a suction cup. Instead of a suction cup, the surface attachment member 24 could also be an adhesive pad 98 (only shown in FIG. 5) that connects with the surface attachment device housing 22. With reference back to the illustrated embodiment, the surface attachment member 24 includes a contact surface 100 configured to contact the surface S against which the surface attachment device 12 is to be retained. With reference to FIG. 4, the surface attachment member 24 also includes a rear surface 102, which is opposite the contact surface 100. A pocket 104 is provided on the rear surface 102 to connect the surface attachment member 24 to the connector 32. The surface attachment member 24 also includes a projection 106, which can be useful when the surface attachment member 24 is a suction cup to facilitate removing the surface attachment device 12 from the surface S.

The connector 32 in the illustrated embodiment includes an arm 110 and a base 112. The arm 110 extends axially in a rearward direction parallel with the rotational axis 16 (FIG. 3) from the base 112. The base 112 is configured to be received within the pocket 104 of the surface attachment member 24 to connect the connector 32 with the surface attachment member 24. The arm 110 includes an axle hole 114, which receives the axle 28 to connect the connector 32 with the lever 26.

The spring 30 in the illustrated embodiment surrounds the arm 110 of the connector 32 when the surface attachment device 12 is assembled. The spring 30 is a compression spring that is trapped between the surface attachment member 24 and the surface attachment device housing 22. The spring 30 acts against the rear surface 102 of the surface attachment member 24 around the pocket 104 to bias the surface attachment member 24 in a forward axial direction away from the surface attachment device housing 22. The spring 30 contacts the inner surface 46 of the surface attachment device housing 22 when the surface attachment device 12 is assembled. The surface attachment device housing 22 also includes a connector opening 116 which is partially surrounded by the upside down U-shaped projection 48. The arm 110 of the connector 32 extends through the connector opening 116 in the surface attachment device housing 22 when the surface attachment device 12 is assembled.

The lever 26 includes aligned axle openings 120 that receive the axle 28 to connect the lever 26 with the connector 32. The lever 26 includes a cam surface 122 and a handling section 124 spaced from the axle openings 120 and the cam surface 122. The lever 26 pivots about an axis 126 (FIG. 2) defined by the axle 28 to move the connector 32 in an axial direction with respect to the surface attachment device housing 22. In the illustrated embodiment, the actuator assembly, which is made up of the lever 26, the axle 28, the spring 30, and the connector 32, is configured to deform the surface attachment member 24, which in the illustrated embodiment is a suction cup. The cam surface 122 acts against the outer surface 44 of the surface attachment device housing 22 in the vicinity surrounded by the upside down U-shaped projection 48 to move the connector 32 with respect to the surface attachment device housing 22. With the lever 26 in the position shown in FIG. 2, the contact edge 56 on the surface attachment device housing 22 presses against the rear surface 102 of the surface attachment member 24 to deform the surface attachment member 24, which is a suction cup in the illustrated embodiment. Rotating the lever 26 in an unlocked direction 130 from the position shown in FIG. 2 so that the handling section 124 is substantially aligned with the rotational axis 16 moves the cam surface 122 with respect to the surface attachment device housing 22 so that the spring 30 presses against the rear surface 102 of the surface attachment member 24 thus moving the rear surface 102 of the surface attachment member 24 away from the contact edge 56. When the surface attachment member 24 is a suction cup, the surface attachment member 24 flattens (e.g., becomes more planar) thus making it easier to remove the surface attachment device 12 from the surface S.

In the illustrated embodiment, the accessory assembly 14 includes an accessory assembly housing 150, a spring member 152, and an item support 154, which in the illustrated embodiment is a hook. The accessory assembly 14 selectively connects to the surface attachment device 12, which attaches the item support 154 to the surface S. Different item supports can be provided other than the hook shown in the illustrated embodiment. For example, the hook could be replaced with a camera mount, a mobile device mount, a towel holder, a bathroom tool holder, a kitchen tool holder, a soap dish, or the like.

The accessory assembly housing 150 includes a side wall 160 that transitions into a hood 162. The side wall 160 in the illustrated embodiment is circular and centered with respect to the rotational axis 16; however, the side wall could take other configurations. The accessory assembly housing 150 includes an exterior surface 164 and an interior surface 166, which is opposite to the exterior surface 164. A button hole 168, which is most clearly seen in FIG. 5, extends through the side wall 160. As seen when comparing FIG. 2 to FIG. 1, the accessory assembly housing 150 covers the surface attachment device 12 when the accessory assembly 14 is connected with the surface attachment device 12. Moreover, the accessory assembly housing 150 covers the actuator assembly, which is made up of the lever 26, the axle 28, the spring 30, and the connector 32, when the accessory assembly 14 is connected with the surface attachment device 12.

With reference to FIG. 5, the accessory assembly housing 150 also includes a retaining tab 172 that extends inwardly from the side wall 160. The retaining tab 172 is radially aligned with a recess 174. The retaining tab 172 and the recess 174 cooperate with the spring member 152 to retain the spring member 152 inside the accessory assembly housing 150 when the accessory assembly 14 is assembled.

The accessory assembly 14 includes at least one flange (flanges 180, 182, 184, and 186 are depicted in the illustrated embodiment) configured to fit within at least one notch (notches 70, 72, 74, and 76 are provided in the illustrated embodiment) when the at least one flange is aligned with the at least one notch. With reference to FIG. 3, the accessory assembly includes a plurality of inwardly extending flanges: first flange 180, second flange 182, third flange 184, and fourth flange 186. Respective inwardly extending flanges 180, 182, 184, and 186 fit within respective notches 70, 72, 74, and 76 when the accessory assembly 14 is in only one orientation with respect to the surface attachment device 12. In the illustrated embodiment, the first inwardly extending flange 180 is larger than the other flanges, i.e., the second flange 182, the third flange 184, and the fourth flange 186. Likewise, the first notch 70 is larger than the remaining notches, i.e., the second notch 72, the third notch 74, and the fourth notch 76.

To place the accessory assembly 14 on the surface attachment device 12 the first flange 180 is aligned with the first notch 70, the second flange 182 is aligned with the second notch 72, the third flange 184 is aligned with the third notch 74, and the fourth flange 186 is aligned with the fourth notch 76. The accessory assembly 14 is then moved in an axial direction parallel with the rotational axis 16 toward the surface attachment device 12, which can already be attached to the surface S as shown in FIG. 2. With the inwardly extending flanges 180, 182, 184, and 186 received through the respective notches 70, 72, 74, and 76, the accessory assembly 14 can be rotated in the locking rotational direction 90 (FIG. 3) about the rotational axis 16 so that the flanges 180, 182, 184, and 186 retain the tabs 66, 60, 62, and 64, respectively, to preclude axial movement of the accessory assembly 14 with respect to the surface attachment device 12 after the accessory assembly 14 has been rotated with respect to the surface attachment device into a locked position, which is shown in FIG. 1. When the accessory assembly 14 is rotated in the locking rotational direction 90 after the inwardly extending flanges 180, 182, 184, and 186 have been received in the respective notches 70, 72, 74, and 76, the first flange 180 contacts the stop member 84 on the fourth tab 66, the second flange 182 contacts the stop member 84 on the first tab 60, the third flange 184 contacts the stop member 84 on the second tab 62, and the fourth flange 186 contacts the stop member 84 on the third tab 64 when the accessory assembly 14 is in the locked position, which is shown in FIG. 1. As such, further rotational movement of the accessory assembly 14 with respect to the surface attachment device 12 in the locking rotational direction 90 is precluded.

The spring member 152 in the illustrated embodiment is ring-shaped, although not completely circular but instead oval-shaped when connected with the accessory assembly housing 150 when not acted upon by an external force. As such, at least a portion of the spring member 152 is offset from the side wall 160 of the accessory assembly housing 150 when the spring member 152 is retained within the accessory assembly housing 150 and not acted upon by an external force such as an operator biasing the spring member 152 or the latch 96 contacting the spring member 152 in a manner described in more detail. The spring member 152 includes a notch 200 and a tab 202. The retaining tab 172 on the accessory assembly housing 150 fits within the notch 200 and the tab 202 fits within the recess 174 to connect the spring member 152 to the accessory assembly housing 150. The spring member 152 also includes a button 204. The button 204 extends through the button hole 168 in the side wall 160 of the accessory assembly housing 150 when the spring member 152 is connected with the accessory assembly housing 150. The button 204 is accessible from the exterior surface 164 of the accessory assembly housing 150 and the button 204 is operatively connected with the remainder of the spring member 152 to allow the operator to selectively deform the spring member 152.

In the illustrated embodiment, the accessory assembly 14 also includes a catch 210. The catch 210 engages the latch 96 to preclude rotational movement of the accessory assembly 14 with respect to the surface attachment device 12. The spring member 152 biases the catch 210 in a direction not parallel with the rotational axis 16 (FIG. 3). In the illustrated embodiment, the catch 210 is provided on or in the spring member 152. More particularly to the illustrated embodiment, the catch 210 includes a ramp 212 on the spring member 152 and a recess 214 provided in the spring member 152.

With reference to FIG. 2, the accessory assembly 14 is moved axially (in a direction parallel with the rotational axis 16) with respect to the surface attachment device 12 so that the inwardly extending flanges 180, 182, 184, and 186 align with and pass through the respective notches 70, 72, 74, and 76. After the flanges 180, 182, 184, and 186 pass through the respective notches 70, 72, 74, and 76, the accessory assembly 14 is rotated in the locking rotational direction 90 and the latch 96 moves the spring member 152 and the catch 210 radially inwardly so that the spring member passes through a gap 220 provided between the latch 96 and the annular shoulder 54. As the accessory assembly 14 continues to be rotated in the locking rotational direction 90, the catch 210 moves with respect to the latch 96 until the latch 96 is received within the recess 214 in the illustrated embodiment, so that the latch 96 engages the catch 210. The accessory assembly 14 is rotated from the orientation shown in FIG. 2 to the orientation shown in FIG. 1, which is the locked position. With the latch 96 engaged with the catch 210, rotational movement of the accessory assembly 14 with respect to the surface attachment device 12 is precluded.

To remove the accessory assembly 14 from the surface attachment device 12, an operator presses the button 204 radially inwardly, which moves the catch 210 radially inwardly with respect to the surface attachment device 12. As such, the catch 210 and the spring member 152 moves into the gap 220 between the latch 96 and the annular shoulder 54, which allows for the accessory assembly 14 to be rotated in the unlock rotational direction 94 to align the flanges 180, 182, 184, and 186 with the respective notches 70, 72, 74, and 76. The accessory assembly 14 is rotated with respect to the surface attachment device 12 in the unlock rotational direction 94 until the flanges 180, 182, 184, and 186 engage (contact) respective unlock stop members 92 at which time the accessory assembly 14 is in an unlocked position. With the flanges 180, 182, 184, and 186 aligned with the respective notches 70, 72, 74, and 76, the accessory assembly 14 can be moved in an axial direction away from the surface attachment device 12 to remove the accessory assembly 14 from the surface attachment device 12.

In the illustrated embodiment, the item support 154 is a hook is provided on the accessory assembly 14 and connects with the accessory assembly housing 150. In alternative embodiments, the accessory assembly housing can be integrally formed with an accessory support, such as a hook, a camera mount, a mobile device mount, a towel holder, a bathroom tool holder, a kitchen tool holder, a soap dish, or the like. Moreover, these different accessory holders can connect with the accessory assembly housing 150 similar to the manner in which the hook connects with the accessory assembly housing 150.

A device 10 for mounting to a surface S has been described above with particularity. Modifications and alterations will occur to those upon reading and understanding the detailed description provided above. For example, the latch 96 is depicted provided with the surface attachment device 12 and the catch 210 and the spring member 152 are depicted provided with the accessory assembly 14. In an alternative arrangement, the latch 96 could be provided with the accessory assembly 14, and the catch 210 and the spring member 152 could be provided with the surface attachment device 12. In either arrangement, the spring member 152 cooperates with the catch 210 such that the spring member 152 biases the catch 210 in a direction not parallel with the rotational axis 16. The invention, however, is not limited to only the embodiments described above. Instead, the invention is broadly defined by the appended claims and the equivalents thereof.

What is claimed is:

1. A device for mounting to a surface, the device comprising:
a surface attachment device including a surface attachment member having a contact surface configured to contact a surface against which the surface attachment device is to be retained;
an accessory assembly selectively connectable to the surface attachment device, the accessory assembly being selectively rotatable about a rotational axis with respect to the surface attachment device when connected with the surface attachment device; and
a locking mechanism including a latch, a catch and a spring member, the latch being provided with one of the surface attachment device and the accessory assembly, the catch and the spring member being provided with the other of the surface attachment device and the accessory assembly, the spring member cooperating with the catch such that the spring member biases the catch in a direction not parallel with the rotational axis.

2. The device of claim 1, wherein the accessory assembly is rotatable with respect to the surface attachment device into a locked position in which the catch engages the latch to preclude rotational movement of the accessory assembly with respect to the surface attachment device.

3. The device of claim 1, wherein the surface attachment device includes at least one tab defining at least one notch, and the accessory assembly includes at least one flange configured to fit within the at least one notch when the at least one flange is aligned with the at least one notch.

4. The device of claim 3, wherein the at least one flange retains the at least one tab to preclude axial movement of the accessory assembly with respect to the surface attachment device after the accessory assembly has been rotated with respect to the surface attachment device into a locked position.

5. The device of claim 4, wherein the surface attachment device includes a lock stop member that engages the at least one flange when the accessory assembly is in the locked position.

6. The device of claim 5, wherein the lock stop member extends in a forward axial direction from a forward facing surface of the at least one tab, and the latch extends in a rearward axial direction from a rearward facing surface of the at least one tab.

7. The device of claim 5, wherein the surface attachment device includes a unlock stop member that engages the at least one flange when the accessory assembly is in an unlocked position where the at least one flange is aligned with the at least one notch such that the at least one flange can pass through the at least one notch.

8. The device of claim 7, wherein the unlock stop member extends in a forward axial direction from a forward facing surface of the at least one tab, and the latch extends in a rearward axial direction from a rearward facing surface of the at least one tab.

9. The device of claim 1, wherein the surface attachment device includes a surface attachment device housing including a plurality of outwardly extending tabs and a plurality of notches, and the accessory assembly includes an accessory assembly housing including a plurality of inwardly extending flanges, wherein respective inwardly extending flanges of the plurality of inwardly extending flanges fit within the respective notches of the plurality of notches when the accessory assembly is in only one orientation with respect to the surface attachment device.

10. The device of claim 1, wherein the surface attachment device is an adhesive pad.

11. The device of claim 1, wherein the surface attachment device is a suction cup.

12. The device of claim 11, wherein the surface attachment device includes an actuator assembly configured to deform the suction cup.

13. The device of claim 1, wherein the accessory assembly includes an accessory assembly housing that covers the surface attachment device when the accessory assembly is connected with the surface attachment device.

14. The device of claim 1, wherein the surface attachment device includes an actuator assembly configured to cooperate with the surface attachment member, wherein the accessory assembly includes an accessory assembly housing that covers the actuator assembly when the accessory assembly is connected with the surface attachment device.

15. The device of claim 1, wherein the accessory assembly includes a hook, a camera mount, a mobile device mount, a towel holder, a bathroom tool holder, a kitchen tool holder or a soap dish.

16. The device of claim 1, wherein the spring member is ring shaped.

17. The device of claim 1, wherein the catch is provided on or in the spring member.

18. The device of claim 17, wherein the catch includes a recess provided in the spring member.

19. The device of claim 1, wherein accessory assembly includes an accessory assembly housing and a button accessible from an exterior surface of the accessory assembly housing, wherein the button is operatively connected with the spring member.

20. A method for attaching an accessory assembly to a surface, the method comprising:
attaching a surface attachment device to a surface;
moving the accessory assembly in an axial direction with respect to the surface attachment device; and
rotating the accessory assembly about a rotational axis with respect to the surface attachment device such that a latch moves a catch, which is biased by a spring member, in a direction not parallel with the rotational axis until the catch engages the latch in a locked position to preclude rotational movement of the accessory assembly with respect to the surface attachment device.
